(19) United States
(12) Patent Application Publication
(10) Pub. No.: US 2022/0296029 A1
(43) Pub. Date: Sep. 22, 2022

(54) Coffee or Tea Brewing Apparatus

(71) Applicant: Chao Wen Ma, Edmonton (CA)

(72) Inventor: Chao Wen Ma, Edmonton (CA)

(21) Appl. No.: 17/588,333

(22) Filed: Jan. 30, 2022

(30) Foreign Application Priority Data
Mar. 17, 2021 (CA) 3112142

(51) Int. Cl. A47J 31/06; A47J 31/00

(52) U.S. Cl. CPC A47J 31/0626; A47J 31/0657; A47J 31/005

(57) ABSTRACT

A coffee or tea brewing apparatus comprising a hollow cylinder with top and bottom openings, a permeable filter, a filter retaining ring which attaches to the bottom end of the hollow cylinder and encloses the bottom opening of the hollow cylinder with the permeable filter, a support ring to support the hollow cylinder above an open vessel, and a flexible lid. Coffee grounds or tea leaves are mixed with water inside the hollow cylinder which will then drain through the removable filter effectively separating any liquids into an open vessel while retaining undissolved solids within the hollow cylinder. The flexible lid may be used to enclose the top of the hollow cylinder and pressed on to produce a positive air pressure within the filter assembly to force the liquid through the permeable filter when a faster flow rate is desired.

### CROSS-REFERENCE TO RELATED APPLICATIONS

This application claims benefit of Canada Patent Application No. 3,112,142 filed Mar. 17, 2021, which is incorporated by reference herein in its entirety.

### INTRODUCTION

The present invention pertains generally to beverage preparation. More specifically, the invention relates to a brewing apparatus for the preparation of coffee or tea.

### BACKGROUND

Tea and coffee are typically prepared by the infusion brewing process where tea leaves or coffee grounds are steeped in water for a period of time, or by the percolation brewing process where water is circulated through a bed of coffee grounds or tea leaves.

To separate the solids from the solution of water and coffee grounds or tea leaves, the solution of water and coffee grounds or tea leaves is filtered through a process that is primarily driven by gravity or mechanically produced pressure. Most available coffee or tea brewers are only capable of performing the immersion brewing process or percolation brewing process and a filtration process only driven by gravity or by mechanically produced pressure with no flexibility of alternating between the brew methods or filtration driving processes.

The invention possesses numerous benefits and advantages over known coffee or tea brewers as it provides users with the flexibility of utilizing the infusion or percolation brewing process and also allows for filtration driven by gravity or mechanically produced pressure.

### SUMMARY

The invention pertains to a brewing apparatus for making coffee or tea.

In general, one aspect of the brewing apparatus comprises a hollow cylinder having top and bottom openings for receiving water and coffee grounds or tea leaves, a permeable filter for separating insoluble particles from a solution of coffee grounds or tea leaves mixed in water, a removable filter retaining ring for retaining the permeable filter against the bottom opening of the hollow cylinder therefore enclosing the bottom opening of the hollow cylinder with the permeable filter, a support ring for supporting the brewing apparatus on the rim of an open vessel, and an optional flexible lid for creating air pressure within the hollow cylinder to force liquid through the permeable filter when a faster flow rate of liquid through the permeable filter is desired.

In another aspect of the invention features a brewing apparatus capable of brewing coffee or tea with the immersion brewing process where the filter assembly is assembled together and placed within an open vessel before water and coffee grounds or tea leaves are added into the filter assembly. The solution of water mixed with coffee grounds or tea leaves is then left to steep to dissolve soluble components within the coffee grounds or tea leaves.

In another aspect of the invention features a brewing apparatus capable of brewing coffee or tea with the percolation brewing process where the filter assembly is assembled and supported on top of an open vessel with coffee grounds or tea leaves within the filter assembly. Water is then added into the filter assembly which will percolate through the bed of coffee grounds or tea leaves to dissolve soluble components within the coffee grounds or tea leaves.

In another aspect of the invention features a brewing apparatus capable of separating insoluble particles from a solution of water and coffee grounds or tea leaves. The filter assembly may be supported above an open vessel while containing a solution of water and coffee grounds or tea leaves. The liquid within the solution of water and coffee grounds or tea leaves will then flow through the permeable filter effectively separating the liquid into the open vessel while retaining the coffee grounds or tea leaves within the filter assembly.

In another aspect of the invention features a brewing apparatus capable of creating a positive air pressure within the filter assembly to provide additional driving force to push the liquid within the filter assembly through the permeable filter. This may be done by installing the flexible lid on top of the filter assembly as it contains a solution of water and coffee grounds or tea leaves while arranged in the filtration configuration. The flexible lid will enclose the top opening of the hollow cylinder allowing the user to press down on the flexible lid to simultaneously seal the flexible lid against the cylinder lip and deform the flexible lid into the filter assembly resulting in an increased air pressure within the filter assembly which will push the liquid within the filter assembly through the permeable filter and into the open vessel.

In another aspect of the invention features a brewing apparatus capable of being stored in a compact configuration when not in use. To do so, the filter assembly may be placed into an open vessel with the support ring and flexible lid installed on top.

The invention and its advantages can be better understood upon reading the following non restrictive description, claims, and accompanying drawings.

### BRIEF DESCRIPTION OF THE DRAWINGS

FIG. 1 is a cross sectional view of the brewing apparatus arranged in the storage configuration.

FIG. 2 is a cross sectional view of the brewing apparatus arranged in the filtration configuration.

FIG. 3 is a cross sectional view of the brewing apparatus arranged in the forced flow configuration.

FIG. 4 is a top plan view of the hollow cylinder illustrating the cylinder lip and cylinder handle.

FIG. 5 is a side cross-sectional view of the hollow cylinder illustrating the cylinder lip, cylinder screw thread, and cylinder handle.

FIG. 6 is a top plan view of the filter retaining ring.

FIG. 7 is a side cross-sectional view of the filter retaining ring illustrating the retaining ring screw thread.

FIG. 8 is a top plan view of the support ring illustrating the upper step, support ring handle, and support ring opening.

FIG. 9 is a side cross-sectional view of the support ring illustrating the upper step, lower step, and support ring handle.

FIG. 10 is a top plan view of the flexible lid illustrating the handle penetration.

FIG. 11 is a side cross sectional view of the flexible lid illustrating the lid lip, handle penetration, and skirt.

FIG. 12 is a side exploded view of the filter assembly.

FIG. 13 is a side cross sectional view of the brewing apparatus illustrating the immersion brewing process.

FIG. 14 is a side cross sectional view of the brewing apparatus illustrating the percolation brewing process and illustrates the filtration process.

FIG. 15 is a side cross sectional view of the brewing apparatus illustrating the forced flow process.

### DETAILED DESCRIPTION OF THE INVENTION

The hollow cylinder 2 comprises a cylinder lip 3 to support the filter assembly 1 on top of an open vessel 18 during the infusion brewing process, cylinder screw thread 4 to attach the filter retaining ring 6, and a cylinder handle 5 for handling the filter assembly 1.

The filter retaining ring 6 is formed with a retaining ring screw thread 7 to attach the filter retaining ring 6 to the bottom of the hollow cylinder 2.

The permeable filter 8 is flat, thin, circular in shape, and is made of a permeable material.

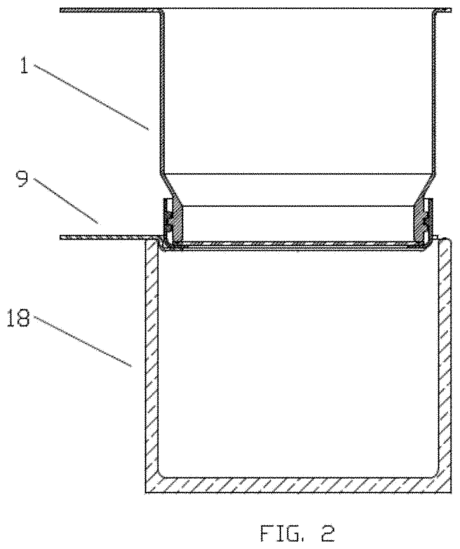

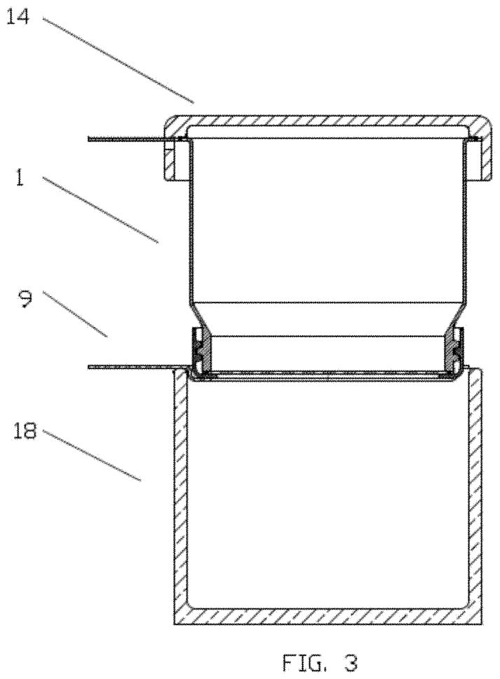

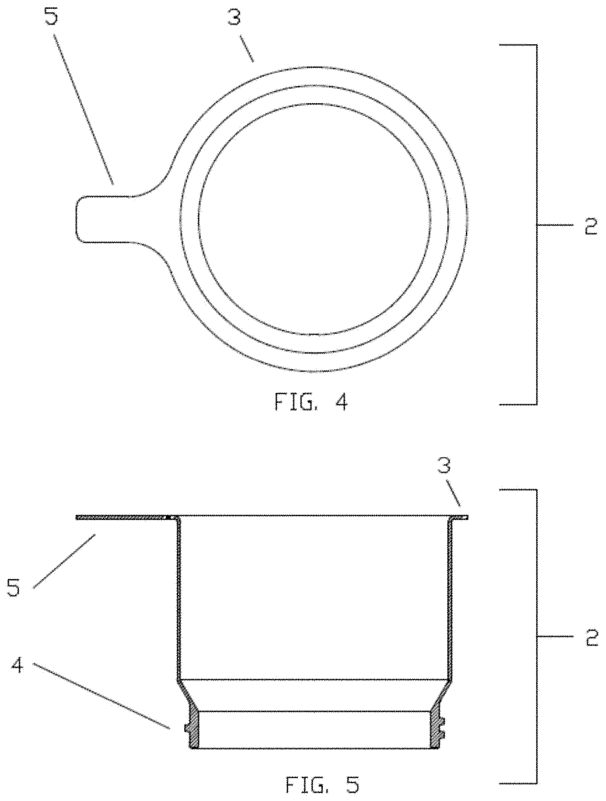

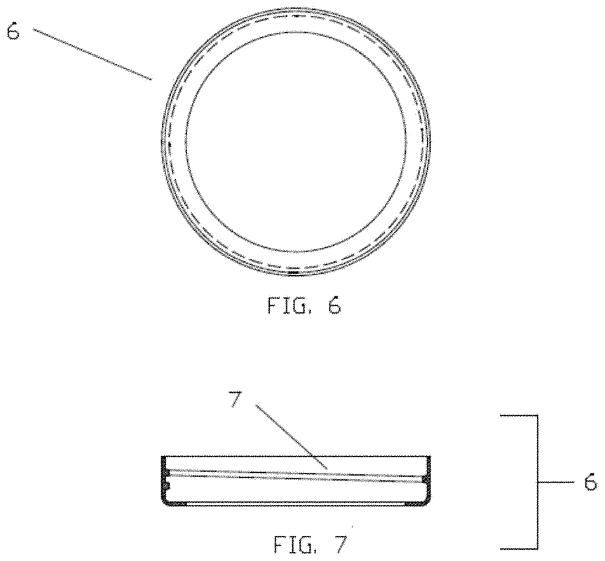

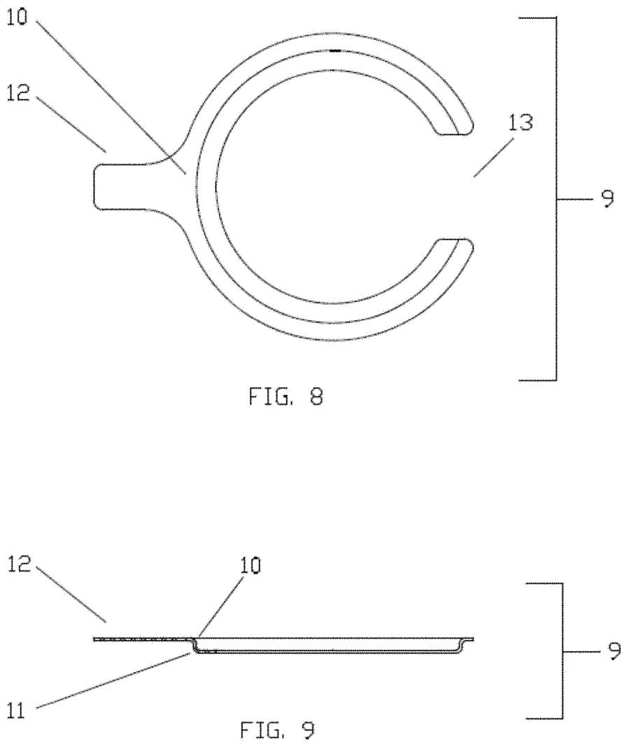

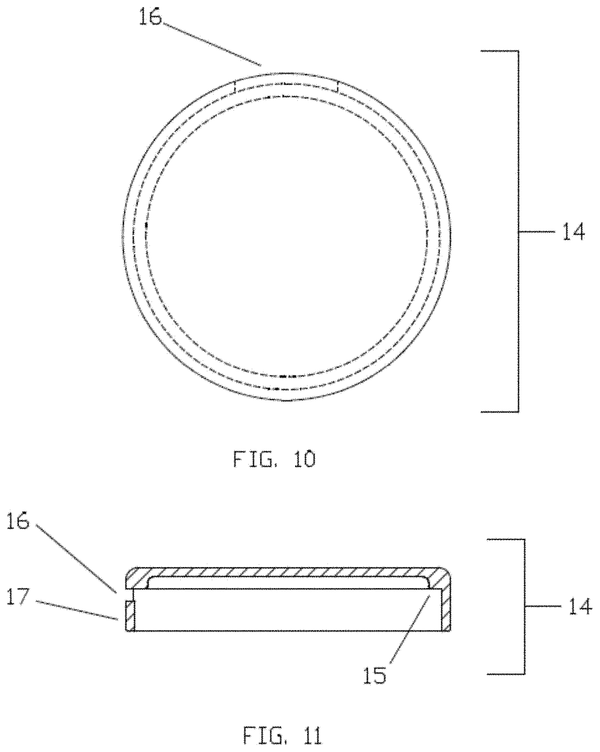

The support ring 9 is formed with an upper step 10 to prevent the filter assembly 1 from slipping off of the support ring 9, a lower step 11 to prevent the support ring from slipping off of the open vessel 18, a support ring handle 12 for handling the support ring 9, and a support ring opening 13 to allow for air to flow freely out of the open vessel 18 when the brewing apparatus is arranged in the filtration configuration as illustrated in FIG. 2.

The flexible lid 14 is formed with a lid lip 15 for sealing against the cylinder lip 3, handle penetration 16 to allow the cylinder handle 5 and support ring handle 12 to protrude through the flexible lid 14, skirt 17 to wrap around the top of an open vessel 18, and is made of a flexible material similar to rubber or silicone.

According to a specific embodiment of the brewing apparatus, the brewing apparatus comprises a hollow cylinder 2 having top and bottom openings, a permeable filter 8, a filter retaining ring 6 when installed with the permeable filter 8 on the hollow cylinder 2, will enclose the bottom opening of the hollow cylinder 2 with the permeable filter 8, a removable support ring 9, and a removable flexible lid 14.

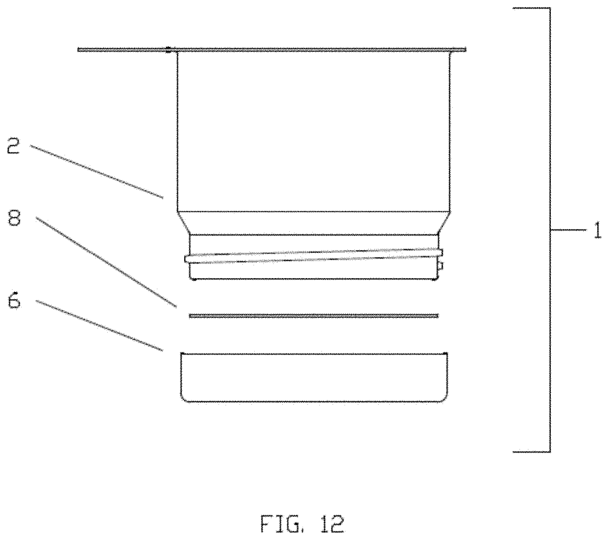

To assemble the filter assembly 1, the filter retaining ring 6 and permeable filter 8 are installed on the bottom opening of the hollow cylinder 2 in a fashion which secures the permeable filter 8 against the bottom of the hollow cylinder 2 and encloses the bottom opening of the hollow cylinder 2 with the permeable filter 8 as shown in FIG. 12.

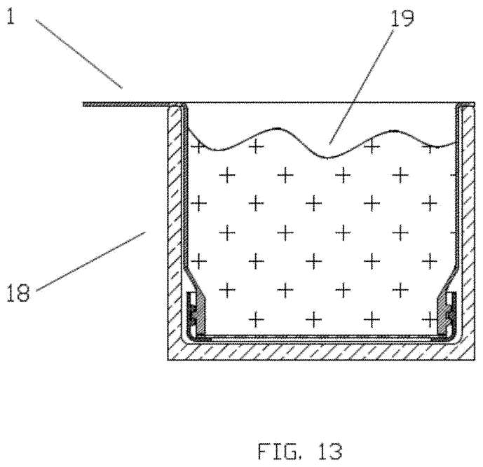

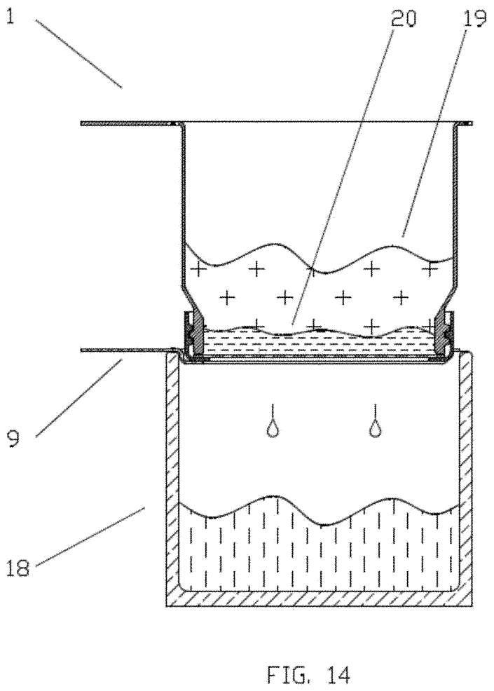

To use the brewing apparatus for the immersion brewing process, the filter assembly 1 is inserted into an open vessel 18. Water and coffee grounds or tea leaves are then added into the filter assembly to begin the steeping process as illustrated by FIG. 13. Once the steeping process is complete, the filter assembly 1 may be lifted up with the cylinder handle 5 and then supported on top of the open vessel 18 with the support ring 9 to start the filtration process as shown by FIG. 14 where the liquid within the solution of water and coffee grounds or tea leaves 19 inside the filter assembly 1 will flow through the permeable filter 8 by the force of gravity, effectively separating the liquid into the open vessel 18 and retaining the coffee grounds or tea leaves 20 within the filter assembly 1.

To use the brewing assembly for the percolation brewing process, the filter assembly 1 may be supported on top of an open vessel 18 with the support ring 9 as shown in FIG. 2. Coffee grounds or tea leaves are first added into the filter assembly 1. Water is then added into the filter assembly 1 where the water will first percolate through the bed of coffee grounds or tea leaves 20 to dissolve any soluble materials and then flow through the permeable filter 8 into the open vessel 18 by the force of gravity while the permeable filter 8 retains the coffee grounds or tea leaves 20 within the filter assembly 1 as shown in FIG. 14.

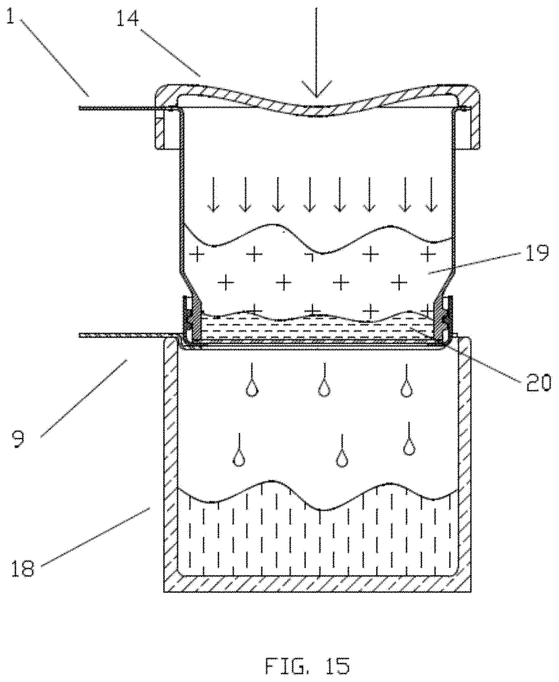

Optionally, to accelerate the liquid within the filter assembly 1 through the permeable filter 8 when an increased flow rate is desired, the flexible lid 14 may be installed on top of the filter assembly 1 and pressed down on as shown in FIG. 15 where the flexible lid 14 will simultaneously seal against the cylinder lip 3 and deform into the filter assembly 1 to create a positive air pressure which will assist in forcing the remaining liquid within the filter assembly 1 through the permeable filter 8 and into the open vessel 18.

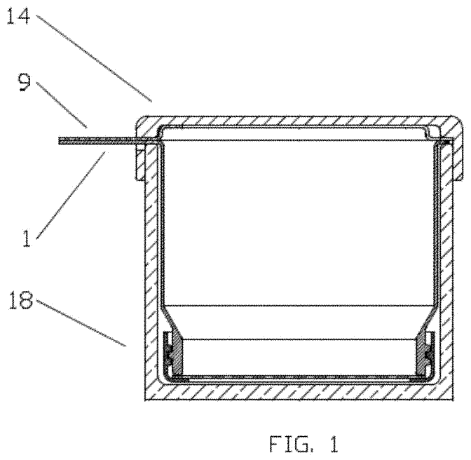

When the brewing apparatus is not in use, the filter assembly 1 may be placed inside an open vessel 18 with the support ring 9 and flexible lid 14 installed on top of filter assembly 1 as shown in FIG. 1 to produce a compact configuration for storage.

The complete description above describes certain embodiments of the brewing assembly and does not represent an exhaustive list of all possible embodiments. It should be understood that one skilled in the art may make modifications or additions without departing from the spirit and scope of the brewing apparatus as defined in the following claims.

What is claimed is:

1. A coffee or tea brewing apparatus comprising:
A hollow cylinder having top and bottom openings;
A removable permeable filter;
A removable filter retaining ring which encloses the bottom opening of said hollow cylinder with said permeable filter;
A removable support ring which supports said filter assembly on top of said open vessel; and
A removable flexible lid, when installed on the top opening of said filter assembly and force is exerted on the lid, seals against said cylinder lip and creates positive air pressure within said filter assembly.

2. The brewing apparatus of claim 1 wherein said filter retaining ring is formed with top and bottom openings to allow said filter retaining ring to install around the bottom of said hollow cylinder and allow for liquids to flow out the bottom opening of said filter retaining ring.

3. The brewing apparatus of claim 1 wherein said filter retaining ring and said hollow cylinder are formed with matching screw thread to allow said retaining ring to attach to the bottom opening of said hollow cylinder.

4. The brewing apparatus of claim 1 wherein said filter retaining ring and said hollow cylinder are formed to retain said permeable filter against the bottom surface of said hollow cylinder once assembled together.

5. The brewing apparatus of claim 1 wherein said support ring is formed with said lower step which extends below the opening of said open vessel to prevent said support ring from slipping off of said open vessel.

6. The brewing apparatus of claim 5 wherein said support ring is formed with said upper step extending below the upper surface of said support ring to prevent said filter assembly from slipping off of said support ring.

7. The brewing apparatus of claim 6 wherein said support ring is removable to allow said filter assembly to be inserted into said open vessel.

8. The brewing apparatus of claim 7 wherein said support ring is formed with said support ring opening to permit air to escape out of said open vessel.

9. The brewing apparatus of claim 8 wherein said support ring is formed with said support ring handle to allow for handling of said support ring.

10. The brewing apparatus of claim 1 wherein said hollow cylinder is formed with said cylinder lip extending radially outward from the top opening which supports said filter assembly on the opening of said open vessel when said filter assembly is inserted into said open vessel.

11. The brewing apparatus of claim 10 wherein said hollow cylinder is formed with said cylinder handle to allow for handling of said hollow cylinder.

12. The brewing apparatus of claim 1 wherein said flexible lid is formed with said skirt along the outside perimeter to wrap around the top opening of said open vessel.

13. The brewing apparatus of claim 12 wherein said flexible lid is formed with said handle penetration to allow said hollow cylinder handle and said support ring handle to protrude through said flexible lid.

14. The brewing apparatus of claim 13 wherein said flexible lid is formed with said lid lip to seal against said cylinder lip.

15. The brewing apparatus of claim 14 wherein said flexible lid is made of a flexible material allowing it to deform when force is applied to it.

16. A coffee or tea brewing apparatus comprising:
A hollow cylinder having top and bottom openings;
A removable permeable filter; and
A removable filter retaining ring which encloses the bottom opening of said hollow cylinder with said permeable filter.
